(19) United States
(12) Patent Application Publication
(10) Pub. No.: US 2025/0310464 A1
(43) Pub. Date: Oct. 2, 2025

(54) Method and System for Document Ownership using Decentralized Identity

(71) Applicant: Konica Minolta Business Solutions U.S.A., Inc., Ramsey, NJ (US)

(72) Inventor: Hironori HIROBE, Foster City, CA (US)

(73) Assignee: Konica Minolta Business Solutions U.S.A., Inc., Ramsey, NJ (US)

(21) Appl. No.: 18/622,754

(22) Filed: Mar. 29, 2024

(51) Int. Cl. H04N 1/44; G06F 3/12; H04N 1/00

(52) U.S. Cl. CPC H04N 1/444; G06F 3/1222; G06F 3/1238; G06F 3/1288; H04N 1/00244; H04N 1/442; H04N 2201/0094

(57) ABSTRACT

A method for document ownership for one or more users of a multifunction printer. The method includes: receiving, by the multifunction printer, a request to execute one or more of a print job and a scan job; forwarding, by the multifunction printer, a request to a decentralized identity server for authorization to execute one or more of the print job and the scan job received by the multifunction printer; receiving, by the multifunction printer, a response from the decentralized identity server for the authorization to execute the one or more of the print job and the scan job received by the multifunction printer; and executing, by the multifunction printer, the one or more of the print job and the scan job when the response from the decentralized identity server authorizes the execution of the one or more of the print job and the scan job.

### FIELD OF THE DISCLOSURE

The present disclosure generally relates to a method and system for document ownership, and more particularly a method and system for document ownership using decentralized identity of printed documents for one or more users of a multifunction printer.

### BACKGROUND

Functions of a multifunction printer (MFP) can include making copies, scanning, faxing, duplex printing, color printing, etc. However, printer documents can be exposed or accessed by an unintended user and/or an unauthorized user, for example, in an office, by removing the printed document from the multifunction printer without the permission of the owner or intended recipient.

Document files (or data), however, can be restricted or secured, for example, with a password. Currently, however, systems are not in place that can seamlessly manage digital (data) and analog (paper) documents including the handing or transferring of printed documents to unintended or unauthorized users without any permission.

### SUMMARY

In accordance with an embodiment, a system and method are disclosed that are able to manage file data and printed paper or printed documents seamlessly with a decentralized identity.

A method is disclosed for document ownership for one or more users of a multifunction printer, the method comprising: receiving, by the multifunction printer, a request to execute one or more of a print job and a scan job; forwarding, by the multifunction printer, a request to a decentralized identity server for authorization to execute one or more of the print job and the scan job received by the multifunction printer; receiving, by the multifunction printer, a response from the decentralized identity server for the authorization to execute the one or more of the print job and the scan job received by the multifunction printer; and executing, by the multifunction printer, the one or more of the print job and the scan job when the response from the decentralized identity server authorizes the execution of the one or more of the print job and the scan job.

A method is disclosed for document ownership associated with a multifunction printer, the method comprising: receiving, by a decentralized identity server, a request for authorization to execute one or more of a print job and a scan job from the multifunction printer; retrieving, by the decentralized identity server from a distributed ledger, one or more permissions for the one or more of the print job and the scan job; determining, by the decentralized identity server, if the multifunction printer is authorized to execute the one or more of the print job and the scan job based on the retrieved one or more permissions for the one or more of the print job and the scan job; and sending, by the decentralized identity server, a response to the request for authorization to execute the one or more of the print job and the scan job to the multifunction printer with approval or denial of the request for authorization to execute the one or more of the print job or the scan job based on the determination of the retrieved one or more permissions for the one or more of the print job and the scan job.

A system is disclose for document ownership, the system comprising: a multifunction printer having a processor configured to: receive a request to execute one or more of a print job and a scan job; forward a request to a decentralized identity server for authorization to execute one or more of the print job and the scan job received by the multifunction printer; receive a response from the decentralized identity server for the authorization to execute the one or more of the print job and the scan job received by the multifunction printer; and execute the one or more of the print job and the scan job when the response from the decentralized identity server authorizes the execution of the one or more of the print job and the scan job.

It is to be understood that both the foregoing general description and the following detailed description are exemplary and explanatory and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is an illustration of a system for document ownership using decentralized identity for printing and scanning operations executed by one or more users on a multifunction printers (MFP) in accordance with an exemplary embodiment.

FIG. 2 is an illustration of a method for document ownership using decentralized identity for printing by one or more users in accordance with an exemplary embodiment.

FIG. 3 is an illustration of a method for document ownership using decentralized identity for blocking a print job in accordance with an exemplary embodiment.

FIG. 4 is an illustration of a method for document ownership using decentralized identity for print tracking in accordance with an exemplary embodiment.

FIG. 5 is an illustration of a method for document ownership using decentralized identity for print tracking in accordance with another exemplary embodiment.

FIG. 6 is an illustration of a method for document ownership using decentralized identity for scan tracking denial in accordance with an exemplary embodiment.

FIG. 7 is an illustration of a method for document ownership using decentralized identity for scan tracking approval in accordance with an exemplary embodiment.

FIG. 8 is an illustration of a flowchart for document ownership for one or more users of a multifunction printer in accordance with an exemplary embodiment.

FIG. 9 is an illustration of a flowchart for a method for document ownership associated with a multifunction printer in accordance with an exemplary embodiment.

FIG. 10 is an illustration of an exemplary hardware architecture for an embodiment of a computer system.

### DETAILED DESCRIPTION

Reference will now be made in detail to the present preferred embodiments of the invention, examples of which are illustrated in the accompanying drawings. Wherever possible, the same reference numbers are used in the drawings and the description to refer to the same or like parts.

Multifunction peripherals or multifunction printers (MFP) often require users to login so that the managed print services can be implemented. The managed print services can include, for example, user authentication that control identities of users, which can help ensure that users have been authenticated at the MFP before a print job is released and/or printed. In addition, managed print services allow administrators to track and monitor usage in real time through regular, scheduled and on-demand reporting, management, and charge back of costs by assigning users to cost centers, entering of billing or project codes before printing a document. Managed print services can also create print rules or policies, which can help ensure, for example, cost management by allowing different user roles to access different devices and features. For example, duplex printing and/or color printing may be allowed by certain individuals and/or groups and not permitted to other individuals and/or groups.

In addition, depending on the user level access to the managed print services, some of the regular operations, which a user may perform regularly, for example, making copies with booklet binding, stapling, printing a color cover page with black and white inside pages, scanning to a PDF file, and sending to email group, may not be the same on each and every multifunction printer. In accordance with an embodiment, the method and system are disclosed for document ownership using a decentralized identity for each of the one or more users of a multifunction printer (MFP).

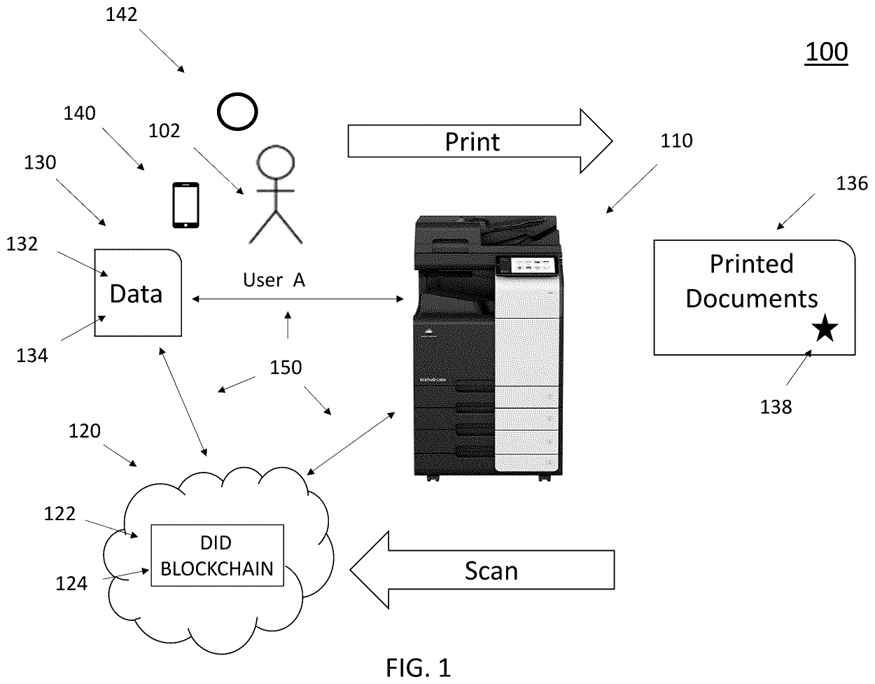

FIG. 1 is an illustration of a system 100 for a system for document ownership using decentralized identity for printing and scanning operations executed by one or more users 102 on a multifunction printers (MFP) 110. As shown in FIG. 1, the system 100 can include one or more multifunction printers (MFP) 110, a cloud computing system 120, and a computer system 130. The computer system 130, can be, for example, a personal computer. The cloud computing system 120 can include one or more decentralized identity (DID) servers 122. The one or more decentralized identity (DID) servers 122 can include an open-standards based identity framework using, for example, a blockchain 124 that can be used for identity verification (for example, document ownership and sharing), and authentication and authorization of users.

In accordance with an embodiment, the one or more decentralized identity (DID) servers 122 can include an open-standards based identity framework that uses digital identifiers and verifiable credentials that are self-owned, independent, and enables trusted data exchange. For example, the one or more decentralized identity (DID) servers 122 can use cryptography, blockchain, and other decentralized technologies to give a user 102 ownership over their digital identities and control over how data 132 of the user 102 is accessed and used.

Each user 102 can be issued a unique decentralized identifier that can be used, for example, on a blockchain 124 or other distributed ledger technologies, which can help ensure security and immutability, for example, of data 132 and associated documents 134. In accordance with an embodiment, the data 132 of the user 102 can be stored on the one or more decentralized identifier (DID) servers 122, and wherein the data 132 is cryptographically signed to ensure authenticity as disclosed herein. In accordance with an embodiment, the data 132 and associated documents 134, which have been cryptographically signed can be shared with other users via the multifunction printer 110.

For example, the one or more decentralized identity (DID) servers 122 can be an enabled trusted data exchange, for example, a blockchain 124 hosted on the cloud computing system 120. The blockchain 124 being a distributed, immutable register of sequential data records. A network of one or more computing nodes can collectively operate and administer a blockchain by validating the addition of new data records (“blocks”) to the blockchain using techniques such as proof of work, proof of stake or other appropriate means. Each new block can include a verification data field that is calculated based on data from the prior block, thereby “chaining” them and preventing modifications to the blockchain. In accordance with an exemplary embodiment, the blockchain 124 is preferably a private blockchain. For example, for organizations, businesses, or enterprise corporations, the blockchain 124 is preferably a private blockchain. However, the blockchain 124 can be a public blockchain or a consortium/hybrid blockchain.

As shown in FIG. 1, the system 100 can include the user 102 that can be authenticated on the one or more multifunction printers 110, and/or the computer system 130 via a client device 140, for example, by entry of personal identification number, use of public key infrastructure (PKI) card, or via an authentication process using, for example, a biometric identifier or other authenticator of the user 102. In accordance with an embodiment, the client device 140 can be, for example, a mobile client, for example, a smart phone, a smart tablet, a smart watch, or a biometric band or the like. The authentication of the user 102 on the computer system 110 can be, for example, an authentication workflow for access to the one or more multifunction printers 110. The cloud computing system 120 can include one or more servers, the one or more servers can be, for example, running in a cloud computing environment that can be accessed on demand by the one or more multifunction printers 110.

The one or more multifunction printers 110, the cloud computing system 120, the one or more decentralized identity (DID) servers 122, the computer system 130, and the client device 140 can include a processor or central processing unit (CPU), and one or more memories for storing software programs and data. The processor or CPU carries out the instructions of a computer program, which operates and/or controls at least a portion of the functionality of the one or more multifunction printers 110, the cloud computing system 130, the computer system 130, and the client device 140. The one or more multifunction printers 110, the computer system 120, and the client device 140 can also include an operating system (OS), which manages the computer hardware and provides common services for efficient execution of various software programs. For example, the software programs can include application software, for example, for managing an authentication module and/or biometric identifier, and/or printer driver software, for example, for one or more of the one or more multifunction printers 110, the cloud computing system 120, the computer system 130, and the client device 140.

In accordance with an embodiment, the one or more multifunction printers (MFP) 110 can include at least a copy function, an image reading function, a facsimile (fax) function, and a printer function, and forms an image on a sheet based on a print job multifunction peripheral (print instruction) received, for example, from the computer system 130 or the client device 140. The one or more multifunction printers 110 can include a memory, which stores an identify of one or more users 102 that can be authenticated, for example, via a PIN, a PKI card, or an authentication process using, for example, biometric identifiers of the user 102.

The one or more multifunction printers 110, the cloud computing system 120, the computer system 130, and the client device 140 can be connected via a communication network 150. The communication network 150 may include, for example, a conventional type of network, wired or wireless, and may have any number of configurations, such as a star configuration, token ring configuration, or other known configurations. The communication network 150 may include one or more local area networks (“LANs”), wide area networks (“WANs”) (e.g., the Internet), virtual private networks (“VPNs”), peer-to-peer networks, near-field networks (e.g., Bluetooth®), cellular networks (for example, 3G, 4G, 5G, other generations), and/or any other interconnected data path across which multiple computing nodes may communicate.

Data 132, for example, which is hosted on the computer system 130 may be transmitted in encrypted or unencrypted form between the one or more multifunction printers 110, the cloud computing system 120, the computer system 130, and the client device 140, using a variety of different communication protocols including, for example, various Internet layer, transport layer, or application layer protocols. For example, data may be transmitted between the one or more multifunction printers 110, the cloud computing system 120, the computer system 130, and the client device 140, via the network 150 using transmission control protocol/Internet protocol (TCP/IP), user datagram protocol (UDP), transmission control protocol (TCP), hypertext transfer protocol (HTTP), secure hypertext transfer protocol (HTTPS), dynamic adaptive streaming over HTTP (DASH), real-time streaming protocol (RTSP), real-time transport protocol (RTP) and the real-time transport control protocol (RTCP), file transfer protocol (FTP), WebSocket (WS), wireless access protocol (WAP), various messaging protocols (SMS, MMS, XMS, IMAP, SMTP, POP, WebDAV, etc.), or other known protocols.

In accordance with an embodiment, the user 102 can present an authenticator to one or more multifunction printers 110 and/or the client device 140. The authentication of the user 102 on the one or more multifunction printers 110 and the client device 140 can be via, for example, a security identification and authentication device (or authenticator), which uses automated methods of verifying or recognizing the identity of a living person based on a physiological or behavioral characteristic. Thus, the user 102 may not be required to manually input passwords to the one or more multifunction printers 110. The method of recognizing the user 102 can include, for example, fingerprints, electrocardiogram (ECG or EKG) information, facial images, iris, and voice recognition. For example, in accordance with an exemplary embodiment, a wearable device 142, for example, a Nymi™ band, which detection of the user 102 is based on the electrocardiogram (ECG) and its unique properties, e.g., electrical activity of the heartbeat of the user (e.g., wearer) 102 can be used as an authenticator.

For example, authentication via the client device 140 can include the presentation, for example, of mobile device, smart phone, or smart watch of the user 102 to a vicinity of an authenticator (e.g., client device 140) via a near-field communication (NFC) network (e.g., Bluetooth®) and wherein the user 102 has previously been authenticated on the mobile device or smart phone by one or more of a user identifier (ID) and password and/or a biometric identifier, for example, facial recognition, fingerprint, of the like.

In accordance with an exemplary embodiment, the authentication of the user 102 on the client device 140 can be a biometric identifier, which is a distinctive, measurable characteristics used to label and describe or identify an individual, including a metric related to human characteristics. For example, the biometric identifier can include physiological characteristics of an individual including but not limited fingerprints, palm veins, face recognition, DNA (or deoxyribonucleic acid), palm print, hand geometry, iris recognition, retina, and/or odor/scent.

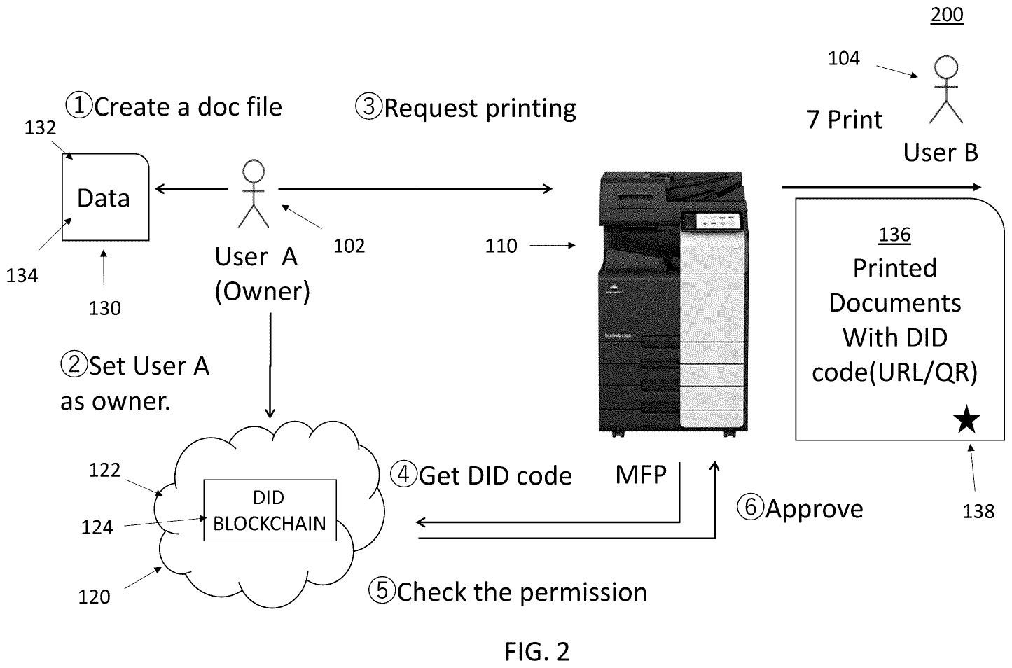

FIG. 2 is an illustration of a method for document ownership 200 using decentralized identity for printing by one or more users 102, 104 in accordance with an exemplary embodiment. As shown in FIG. 2, a first user (User A) 102 can create a document (or document file) 134, for example, on the computer system 130. The document file can include data 132. Once the document (or document file) 134 has been created, the first user (User A) 102 can set the first user (User A) 102 as the owner of the document (or document file) 134, and the information associating the first user (User A) 102 as the owner of the document (or document file) 134 can be sent to the one or more decentralized identity (DID) servers 122 of the cloud computing system 120 for recordation, for example, on the blockchain 124. For example, the information associating the first user (User A) 102 as the owner of the document (or document file) 134 can include embedded authentication into the document (or document file) 134 in the form of a decentralized identity (DID) code. In accordance with an embodiment, the ownership (or authentication) of the document (or document file) 134, the user 102 can set permissions, for example, who can print a copy of the document (or document file) 134, how many copies of the document (or document file) 134 can be printed, and other permissions associated with retrieval and/or printing of the document (or document file) 134. For example, the permissions can also include limitations relating to viewing, editing, printing, and scanning the document (or document file) 134.

Once the ownership of the document created by the first user (User A) 202 and has been recorded on the blockchain 124 of the one or more decentralized identity (DID) servers 122, the first user (User A) 202 can send a print request to the multifunction printer 110 for printing of the document (or document file) 134. Once the multifunction printer 110 receives the print request to print the document (or document file) 134 from the user 102, the multifunction printer 110 will send a request to the one or more decentralized identity (DID) servers 122 for the decentralized identity (DID) code associated with the document (or document file) 134 from the blockchain 124 to determine if the user who requested the printing of the document (or document file) 134, i.e., the first user (User A) 102 has permission to print the document (or document file) 134. The request from the multifunction printer 110 to the one or more decentralized identity (DID) servers 122 will also include an identity of the user, for example, the first user (User A) 102 that is requesting the printing of the document (or document file) 134. For example, in this particular case, the first user (User A) 102 can have a unique user identifier (or user ID) that identifies the first user (User A) 102 from other users, for example, the second user (User B) 104.

In accordance with an embodiment, the one or more decentralized identity (DID) servers 122 can determine if the first user (User A) 102 has permission to print the document (or document file) 134, and the approval or denial can be sent to the multifunction printer 110. For example, as shown in FIG. 2, since the first user (User A) is authorized to print the document (or document file) 134, the multifunction printer 110 executes the printing of the document (or document file) 134 in the form of printed document 136. In accordance with an embodiment, the printed document 136 can include a decentralized identity (DID) code 138 on the printed document itself. For example, the decentralized identity (DID) code 138 can be in the form of a uniform resource locator (URL), a quick response (QR) code, or a user identifier (User ID) for the owner of the printed document 136 and/or the user that sent the print request, for example, the first user (User A) 102. The URL code can be, for example, an address on the Web that is a reference that specifies a location on a computer network and a mechanism for retrieving the document 134.

In addition, in the embodiment shown in FIG. 2, the printed document 136 may be retrieved from the multifunction printer 110 by a second user (User B) 104. The printed document 136 can be one or more documents and wherein each of the one or more documents is comprises of one or more printed pages. For example, the printed document 136 can be a portfolio of documents that can include one or more document such as contracts, proposals, reports, financial documents, certificates, and the like.

In accordance with an exemplary embodiment, as disclosed herein, for each request, for printing or scanning of a document (or document file) 134, a new block can be added to the blockchain 124 using techniques such as proof of work, proof of stake or other appropriate means that a request for the printing or scanning of the document (or document file) 134 has been made with an identifier as to the requesting party or user, for example, the first user (User A) 102 as shown in FIG. 2. As set forth, each new block can include a verification data field that is calculated based on data from the prior block, thereby “chaining” them and preventing modifications to the blockchain so that each and every request received by the one or more centralized identity (DID) servers 122 for printing or scanning of the document (or document file) 134 can be added to the blockchain 124.

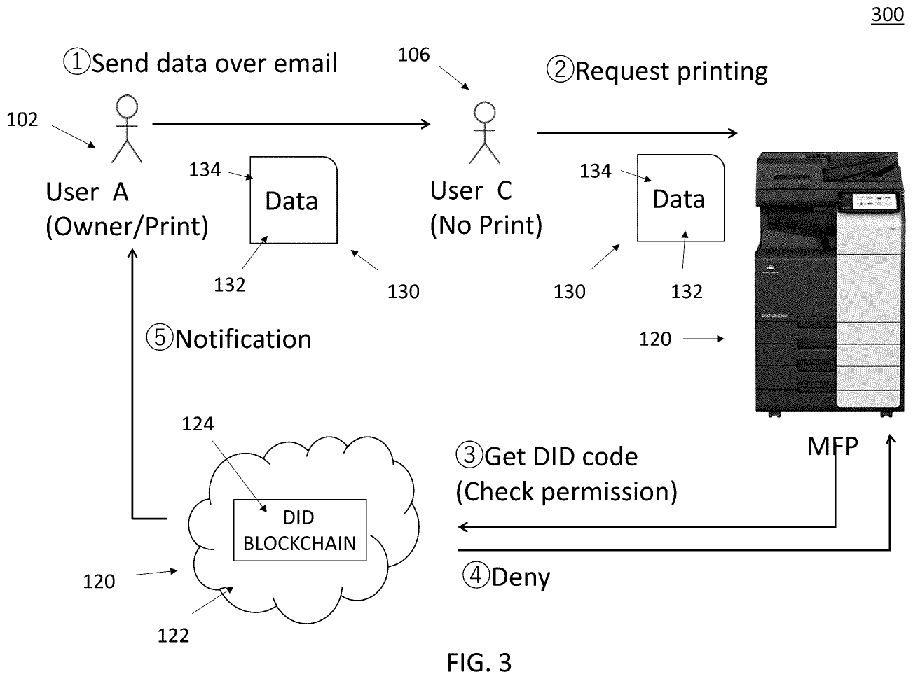

FIG. 3 is an illustration of a method 300 for document ownership using decentralized identity for blocking a print job in accordance with an exemplary embodiment. As shown in FIG. 3, the first user (User A) 102 can send data 132, for example, via an email to a third user (User C) 106. In accordance with an embodiment, the information associating the first user (User A) 102 as the owner of the document (or document file) 134 and the embedded authentication into the document (or document file) 134 can include limitations relating to viewing, editing, printing, and scanning of the document (or document file) 134. For example, the embedded authentication may preclude, for example, the third user (User C) 106 from printing the document (or document file) 134. Rather, for example, the third user (User C) 106 may only have permission to view the document (or document file) 134 rather than printing of the document (or document file) 134.

As shown in FIG. 3, the third user (User C) 106 sends a request to the multifunction printer 110 for printing of the document (or document file) 134. Upon receipt of the request to print the document (or document file) 134 from the third user (User C) 106, the multifunction printer 110 sends a request to the one or more decentralized identity (DID) servers 122 for permissions associated with the document (or document file) 134. The request to the one or more decentralized identity (DID) servers 122 will also include an identity of the user, for example, a unique user ID associated with the third user (User C) 106 that is requesting the printing of the document (or document file) 134. For example, in this particular case, the third user (User C) 106.

Upon receipt of the request from the multifunction printer 110, the one or more decentralized identity (DID) servers 122 can check the blockchain 124 for permissions associated with the document (or document file) 134 requested for printing by obtaining the decentralized identity code stored on the blockchain 124. The one or more decentralized identity (DID) servers 122 checks the decentralized identity code on the blockchain and determines that the third user (User C) 106 does not have permission to print the document (or document file) 134. The one or more decentralized identity (DID) servers 122 responds to the request from the multifunction printer 110 by notifying the multifunction printer 110 that the print request is denied, i.e., the third user (User C) does not have permission to print th the document (or document file) 134.

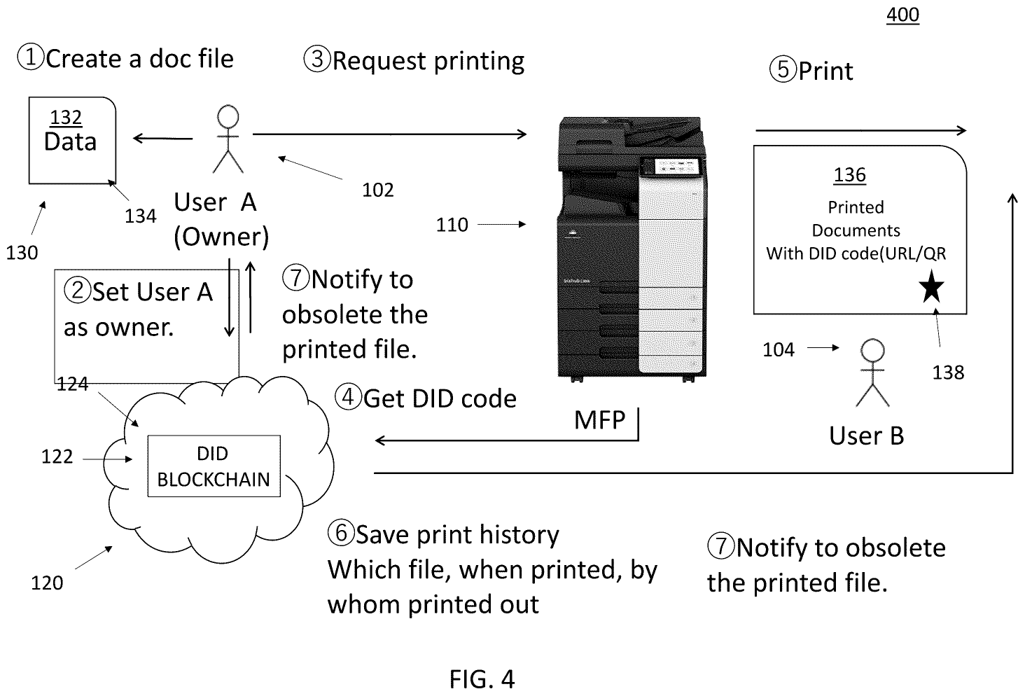

FIG. 4 is an illustration of a method 400 for document ownership using decentralized identity for print tracking in accordance with an exemplary embodiment. As shown in FIG. 4, the first user (User A) 102 can create a document (or document file) 134 on the computer system 130. The document file can include data 132 in the form of the document file 134, for example. Once the document (or document file) 134 has been created, the first user (User A) 102 can set the first user (User A) 102 as the owner of the document (or document file) 134, and the information associating the first user (User A) 102 as the owner of the document (or document file) 134 can be sent to the one or more decentralized identity (DID) servers 122 of the cloud computing system 120 for recordation, for example, on the blockchain 124.

In accordance with an embodiment, the information associating the first user (User A) 102 as the owner of the document (or document file) 134 can include embedded authentication into the document (or document file) 134 in the form of a decentralized identity (DID) code. As set forth above, the user 102 can set permissions, for example, who can print a copy of the document (or document file) 134, how many copies of the document (or document file) 134 can be printed, and other permissions associated with retrieval and/or printing of the document (or document file) 134. For example, the permissions can also include limitations relating to view, edit, print, and scan.

As shown in FIG. 4, the first user (User A) can send a print request to the multifunction printer 110. The multifunction printer 110 receives the print request to print the document (or document file) 134 from the user 102 and sends a request to the one or more decentralized identity (DID) servers 122 for the decentralized identity (DID) code associated with the document (or document file) 134 from the blockchain 124 to determine if the user who requested the printing of the document (or document file) 134, i.e., the first user (User A) 102 has permission to print the document (or document file) 134. The request from the multifunction printer 110 to the one or more decentralized identity (DID) servers 122 will also include an identity of the user, for example, the first user (User A) 102 that is requesting the printing of the document (or document file) 134. For example, in this particular case, the first user (User A) 102 can have a unique user identifier (or user ID) that identifies the first user (User A) 102 from other users, for example, the second user (User B) 104.

For example, as shown in FIG. 4, since the first user (User A) 102 is authorized to print the document (or document file) 134, the multifunction printer 110 executes the printing of the document (or document file) 134 in the form of printed document 136. In accordance with an embodiment, the printed document 136 can include the decentralized identity (DID) code 138 on the printed document itself.

In addition, the one or more decentralized identity (DID) servers 122 can add a new block can be added to the blockchain 124 regarding the print history of the document (or document file) 134. For example, the print history can include which document (or document file) 134 was printed or scanned, when the document (or document file) 134 was printed or scanned, and by whom the document (or document file 134) was printed or scanned. As set forth, each new block can include a verification data field that is calculated based on data from the prior block, thereby “chaining” them and preventing modifications to the blockchain so that each and every request received by the one or more centralized identity (DID) servers 122 for printing or scanning of the document (or document file) 134 can be added to the blockchain 124. In this particular, for example, if the permissions associated with the document (or document file) 134 includes, for example, an expiration date, a number of copies, or other limitations on the printing of the document (or document file) 134, the one or more decentralized identity (DID) servers 122 can send a notice to the first user (User A) 102, or the second user (User B) 104 that the number of printings of the document (or document file) 134 or availability of the document (or document file) 134 has been reached or expired and the permissions for the document (or document file) 134 will preclude future printing of the document (or document file) 134. As shown in FIG. 4, the first user (User A) 102 and the second user (User B) 104 receive a notification that the document (or document file) 134 will no longer be available after a certain number of printing or certain date, or alternatively, that the document (or document file) 134 is no longer available as the permissions set for the document (or document) 134 has expired or the number of printings has been reached.

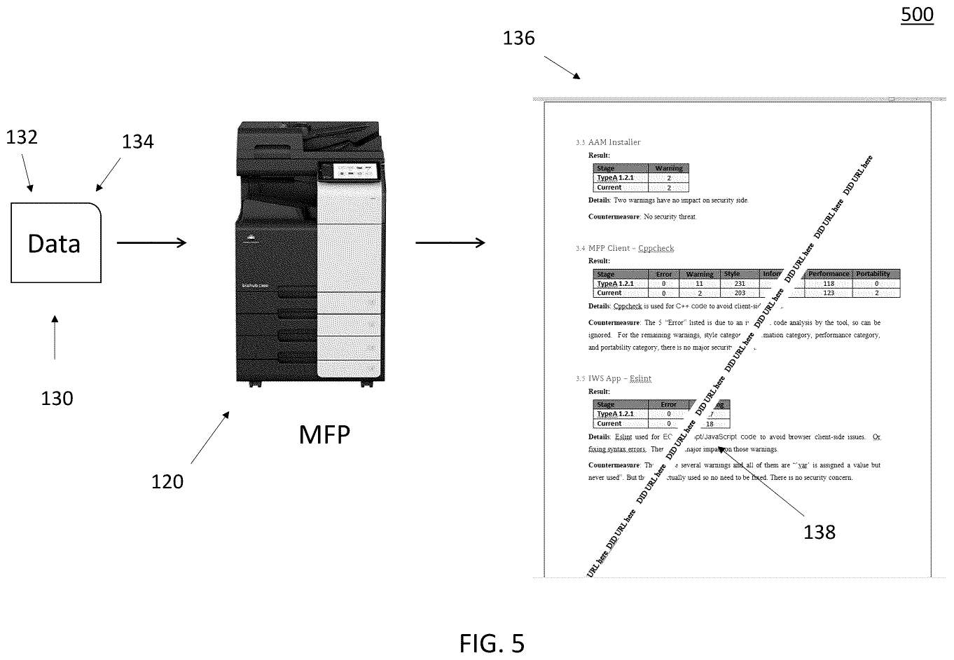

FIG. 5 is an illustration of a method 500 for document ownership using decentralized identity for print tracking in accordance with another exemplary embodiment. As shown in FIG. 5, the printed document 136 can include the decentralized identity (DID) code 138 on the printed document 136 itself. For example, the decentralized identity (DID) code 138 can be in the form of a uniform resource locator (URL) or a quick response (QR) code that is placed on the contents, for example, diagonally across the printed document 136 to prevent the decentralized identity (DID) code 138 from being removed. For example, if the decentralized identity (DID) code 138 is printed on the top or bottom of the printer document 136, the decentralized identity (DID) code 138 can be easily removed or cut off, or covered.

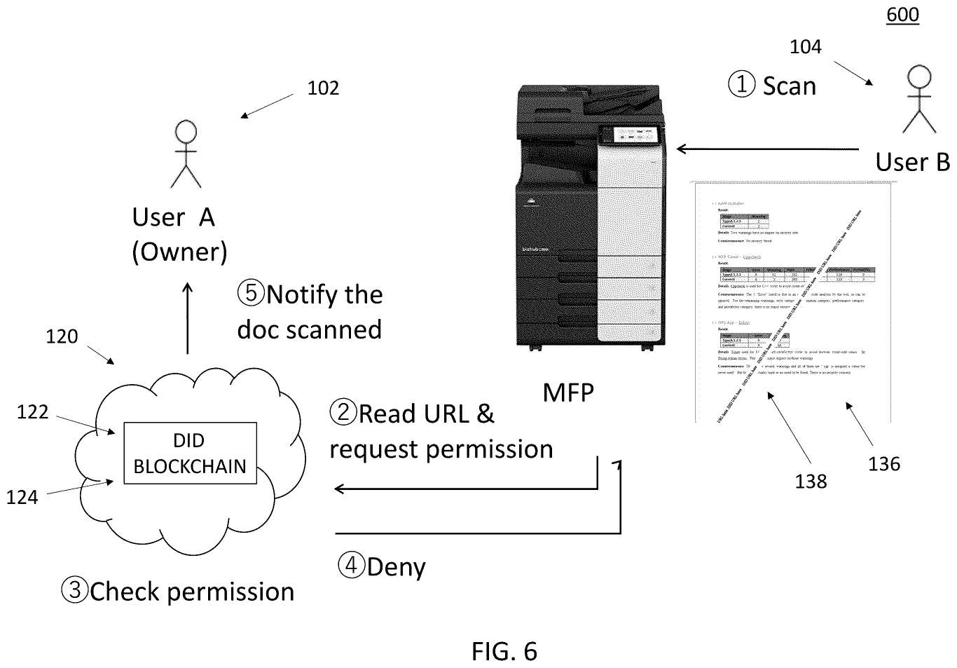

FIG. 6 is an illustration of a method 600 for document ownership using decentralized identity for scan tracking denial in accordance with an exemplary embodiment. As shown in FIG. 6, a second user (User B) 104, may want to scan a printed document 136 that include the decentralized identity (DID) code 138 printed on the printed document 136 itself. The second user (User B) 104 places the printed document 136 on the multifunction printer 110 and request that the printed document be scanned into, for example, a digital format.

The multifunction printer 110 reads the URL (or QR) code 138 printed on the printed document 136 and sends a request to the one or more decentralized identity (DID) servers 122 for permission to scan the printed document 136. The one or more decentralized identity (DID) servers 122 retrieves from the blockchain 124, the permissions associated with decentralized identity (DID) code 138 and can determine that the second user (User B) 104 does not have permission to scan the printed document 136. For example, the second user (User B) 104 may not have permission to scan the printed document, or alternatively, for example, the permissions associated with the printed document 136 may not allow scanning of the printed document 136, i.e., no scan. The one or more decentralized (DID) servers 122 sends a response to the multifunction printer 110 that the request to scan the printed document has been denied.

In addition, the one or more decentralized identity (DID) servers 122 can notify the owner of the printed document 136, for example, in this case, the first user (User A) 102 that the second user (User B) 104, or in general, that a request to scan the printed document 136 has been made.

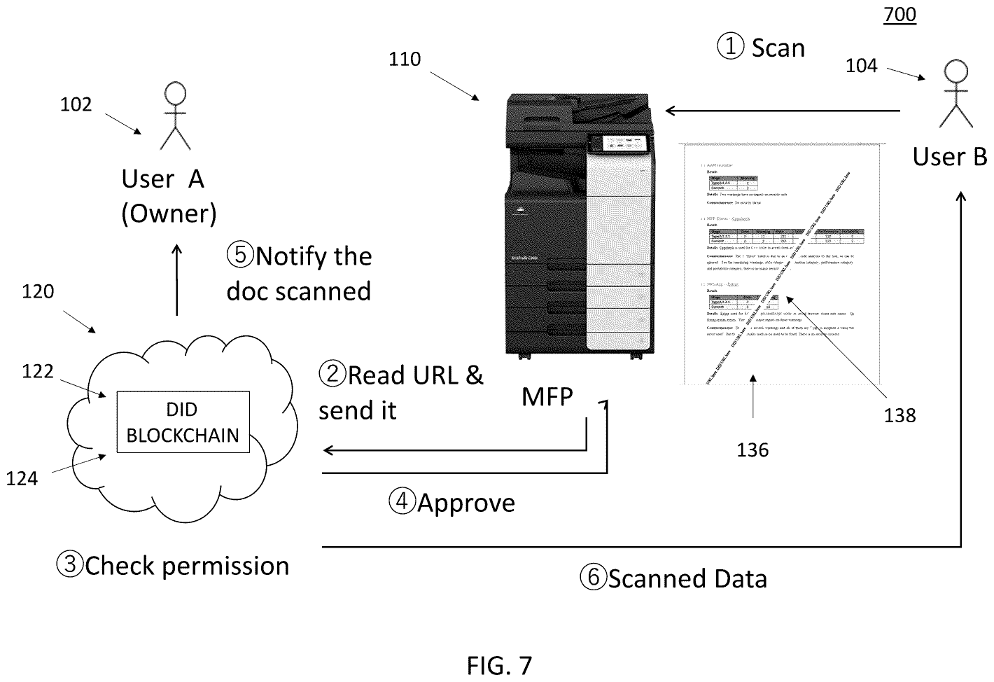

FIG. 7 is an illustration of a method 700 for document ownership using decentralized identity for scan tracking approval in accordance with an exemplary embodiment. As shown in FIG. 7, a second user (User B) 104, may want to scan a printed document 136 that include the decentralized identity (DID) code 138 printed on the printed document 136 itself. The second user (User B) 104 places the printed document 136 on the multifunction printer 110 and request that the printed document be scanned into, for example, a digital format.

The multifunction printer 110 reads the URL (or QR) code 138 printed on the printed document 136 and sends a request to the one or more decentralized identity (DID) servers 122 for permission to scan the printed document 136. The one or more decentralized identity (DID) servers 122 retrieves from the blockchain 124, the permissions associated with decentralized identity (DID) code 138 and can determine that the second user (User B) 104 is permitted to scan the printed document 136. The one or more decentralized identity (DID) servers 122 sends a response to the multifunction printer 110 that the printed document 136 can be scanned, and the scanning of the printed document 136 by the multifunction printer 110 is executed.

In addition, the one or more decentralized identity (DID) servers 122 can notify the owner of the printed document 136, for example, in this case, the first user (User A) 102 that the second user (User B) 104, or in general, that a request to scan the printed document 136 has been made and that the printed document 136 has been scanned and/or will be scanned.

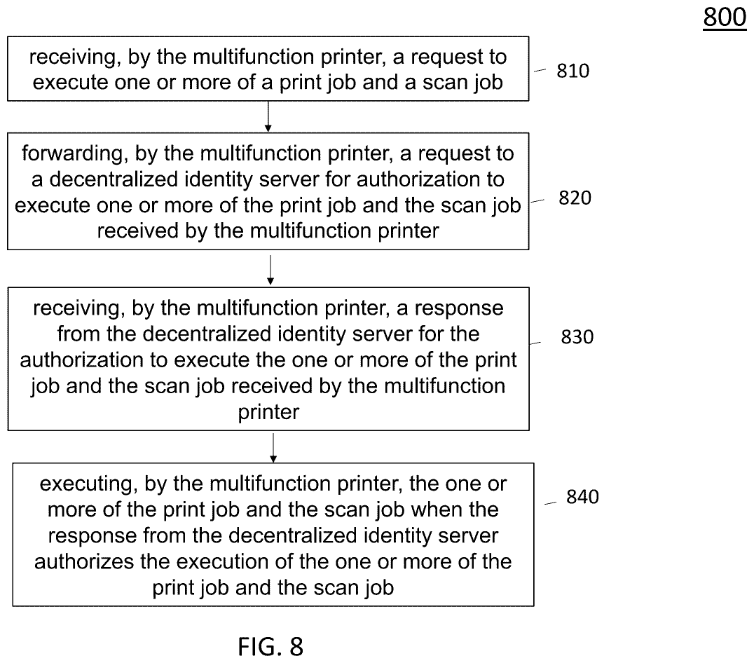

FIG. 8 is an illustration of a flowchart 800 for document ownership for one or more users of a multifunction printer 110 in accordance with an exemplary embodiment. As shown in FIG. 8, the method for document ownership for one or more users of a multifunction printer 110 includes receiving, by the multifunction printer 110, a request to execute one or more of a print job and a scan job (810); forwarding, by the multifunction printer 110, a request to a decentralized identity server 122 for authorization to execute one or more of the print job and the scan job received by the multifunction printer 110 (820); receiving, by the multifunction printer 110, a response from the decentralized identity server 122 for the authorization to execute the one or more of the print job and the scan job received by the multifunction printer 110 (830); and executing, by the multifunction printer 110, the one or more of the print job and the scan job when the response from the decentralized identity server 122 authorizes the execution of the one or more of the print job and the scan job (840).

In accordance with an embodiment, the method further includes sending, by the multifunction printer 110, a user identity associated with the request to execute the one or more of the print job and the scan job to the decentralized identity server 122; and receiving, by the multifunction printer 110, the response from the decentralized identity server 122 for the authorization to execute the one or more of the print job and the scan job received based on the user identity with the request to execute the one or more of the print job and the scan job.

In accordance with an embodiment, when the one or more of the print job and the scan job is the print job, the method further includes: printing, by the multifunction printer 110, the print job with a decentralized identity code on contents of the printed print job, and wherein the decentralized identity code is one or more of a uniform resource locator, a quick response code, and a user identifier. The method also includes receiving, by the multifunction printer 110, a request to execute scanning of the printed print job with the decentralized identity code on the contents of the printed print job; sending, by the multifunction printer 110, the decentralized identity code from the printed print job to the decentralized identity server 122 for authorization to execute the scanning of the printed print job; and receiving, by the multifunction printer 110, the response from the decentralized identity server 122 for the authorization to execute the scan job based on the decentralized identify code.

In accordance with an embodiment, the method further includes reading, by the multifunction printer 110, the decentralized identity code on the contents of the printed print job; and sending, by the multifunction printer 110, the read decentralized identity code on the contents of the printed print job to the decentralized identity server 122.

In accordance with an embodiment, the method further includes authenticating, by the multifunction printer 110, a user of the multifunction printer 110 associated with the one or more of the print job and the scan job based on a biometric identifier for the user, and the biometric identifier is from a biometric authenticator device associated with one of the multifunction printer 110 and a client device, the biometric authenticator device including one or more of a sensor, a scanning device, or an electronic reader, and wherein the biometric identifier of the user being at least one physiological characteristic of the user, and wherein the at least one physiological characteristic is selected from one or more of fingerprints, palm veins, face recognition, DNA (deoxyribonucleic acid), palm print, hand geometry, iris recognition, retina, and/or odor/scent. For example, the client device can be a mobile device, a smart phone, or a wearable device, and wherein the method further includes communicating, by the multifunction printer 110, to the client device of the user via a wireless communication protocol, the wireless protocol being a near-field communication (NFC) or a Bluetooth technology standard.

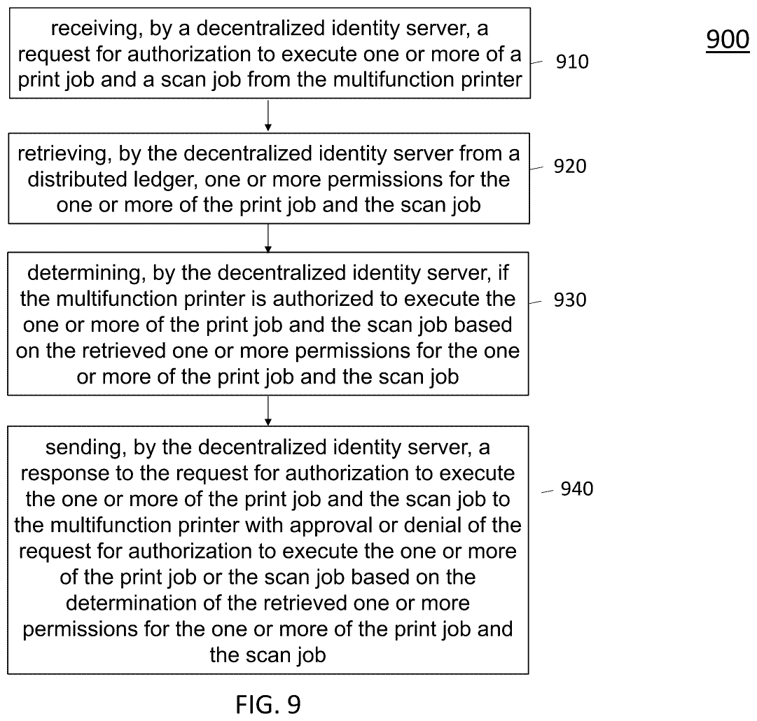

FIG. 9 is an illustration of a flowchart 900 for a method for document ownership associated with a multifunction printer 110 in accordance with an exemplary embodiment. As shown in FIG. 9, the method for document ownership for the multifunction printer 110 includes: receiving, by a decentralized identity server 122, a request for authorization to execute one or more of a print job and a scan job from the multifunction printer 110 (910); retrieving, by the decentralized identity server 122 from a distributed ledger, one or more permissions for the one or more of the print job and the scan job (920); determining, by the decentralized identity server 122, if the multifunction printer 110 is authorized to execute the one or more of the print job and the scan job based on the retrieved one or more permissions for the one or more of the print job and the scan job (930); and sending, by the decentralized identity server 122, a response to the request for authorization to execute the one or more of the print job and the scan job to the multifunction printer 110 with approval or denial of the request for authorization to execute the one or more of the print job or the scan job based on the determination of the retrieved one or more permissions for the one or more of the print job and the scan job (940).

In accordance with an exemplary embodiment, the method further includes receiving, by the decentralized identity server 122, a user identifier associated with the request for authorization to execute the one or more of the print job and the scan job from the multifunction printer 110; and determining, by the decentralized identity server 122, if the multifunction printer 110 is authorized to execute the one or more of the print job and the scan job based on the received user identifier and the retrieved one or more permissions for the one or more of the print job and the scan job from the distributed ledger. The method further includes receiving, by decentralized identity server, the one or more permissions for the one or more of the print job and the scan job; and recording, by the decentralized identity server 122, the one or more permissions for the one or more of the print job and the scan job on the distributed ledger.

In accordance with an exemplary embodiment, the method further includes sending, by the decentralized identity server 122, a notification to one or more users associated with the request for authorization received from the multifunction printer 110 to execute the one or more of the print job and the scan job.

In accordance with an embodiment, the distributed ledger is a blockchain.

In accordance with an exemplary embodiment, the one or more of the print job and the scan job is a scan job, and the method further comprises: receiving, by the decentralized identity server 122, a decentralized identity code from the multifunction printer 110, the decentralized identity code being on contents of a scanned document; determining, by the decentralized identity server 122, if the multifunction printer 110 is authorized to execute the scan job based on the decentralized identity code and permissions associated with the decentralized identity code; and sending, by the decentralized identity server 122, the response to the request for authorization to execute the scan job to the multifunction printer 110 with approval or denial of the request for authorization to execute the scan job.

In accordance with an exemplary embodiment, the method further comprises recording, by the decentralized identity server 122 on the distributed ledger, a history for the one or more of the print job and the scan job that have been printed or scanned including when printed or scanned and an identifier associated with the history for the one or more of the print job and the scan job that have been printed or scanned. The method can also include sending, by the decentralized identity server 122, a notification to one or more users that the one or more of the print job or the scan job has been determined to be obsolete based on a predetermined setting associated with the one or more of the print job or the scan job.

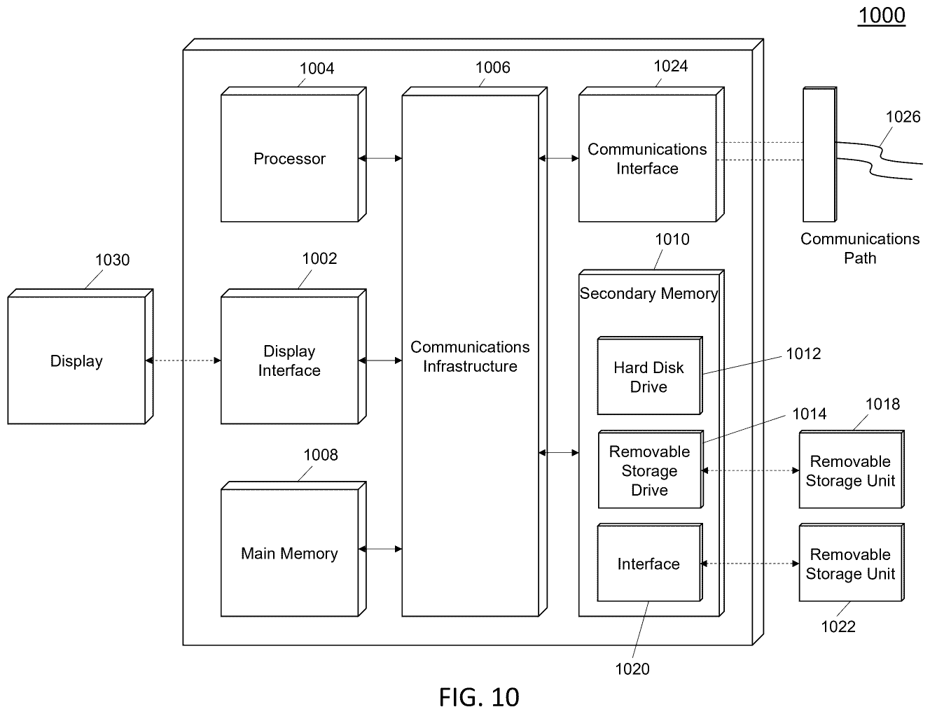

FIG. 10 illustrates a representative computer system 1000 in which embodiments of the present disclosure, or portions thereof, may be implemented as computer-readable code executed on hardware. For example, the one or more multifunction printers 110, the cloud computing system 120, the one or more servers 122, the computer system 130, the client device 140, and the wearable device 142 associated with the method and system for document ownership as disclosed herein may be implemented in whole or in part by a computer system 1000 using hardware, software executed on hardware, firmware, non-transitory computer readable media having instructions stored thereon, or a combination thereof and may be implemented in one or more computer systems or other processing systems. Hardware, software executed on hardware, or any combination thereof may embody modules and components used to implement the methods and steps of the presently described method and system.

If programmable logic is used, such logic may execute on a commercially available processing platform configured by executable software code to become a specific purpose computer or a special purpose device (for example, programmable logic array, application-specific integrated circuit, etc.). A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 1018, a removable storage unit 1022, and a hard disk installed in hard disk drive 1012.

Various embodiments of the present disclosure are described in terms of this representative computer system 1000. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

A processor device 1004 may be processor device specifically configured to perform the functions discussed herein. The processor device 1004 may be connected to a communications infrastructure 1006, such as a bus, message queue, network, multi-core message-passing scheme, etc. The network may be any network suitable for performing the functions as disclosed herein and may include a local area network (“LAN”), a wide area network (“WAN”), a wireless network (e.g., “Wi-Fi”), a mobile communication network, a satellite network, the Internet, fiber optic, coaxial cable, infrared, radio frequency (“RF”), or any combination thereof. Other suitable network types and configurations will be apparent to persons having skill in the relevant art. The computer system 1000 may also include a main memory 1008 (e.g., random access memory, read-only memory, etc.), and may also include a secondary memory 1010. The secondary memory 1010 may include the hard disk drive 1012 and a removable storage drive 1014, such as a floppy disk drive, a magnetic tape drive, an optical disk drive, a flash memory, etc.

The removable storage drive 1014 may read from and/or write to the removable storage unit 1018 in a well-known manner. The removable storage unit 1018 may include a removable storage media that may be read by and written to by the removable storage drive 1014. For example, if the removable storage drive 1014 is a floppy disk drive or universal serial bus port, the removable storage unit 1018 may be a floppy disk or portable flash drive, respectively. In one embodiment, the removable storage unit 1018 may be non-transitory computer readable recording media.

In some embodiments, the secondary memory 1010 may include alternative means for allowing computer programs or other instructions to be loaded into the computer system 1000, for example, the removable storage unit 1022 and an interface 1020. Examples of such means may include a program cartridge and cartridge interface (e.g., as found in video game systems), a removable memory chip (e.g., EEPROM, PROM, etc.) and associated socket, and other removable storage units 1022 and interfaces 1020 as will be apparent to persons having skill in the relevant art.

Data stored in the computer system 1000 (e.g., in the main memory 1008 and/or the secondary memory 1010) may be stored on any type of suitable computer readable media, such as optical storage (e.g., a compact disc, digital versatile disc, Blu-ray disc, etc.) or magnetic storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 1000 may also include a communications interface 1024. The communications interface 1024 may be configured to allow software and data to be transferred between the computer system 1000 and external devices. Exemplary communications interfaces 1024 may include a modem, a network interface (e.g., an Ethernet card), a communications port, a PCMCIA slot and card, etc. Software and data transferred via the communications interface 1024 may be in the form of signals, which may be electronic, electromagnetic, optical, or other signals as will be apparent to persons having skill in the relevant art. The signals may travel via a communications path 1026, which may be configured to carry the signals and may be implemented using wire, cable, fiber optics, a phone line, a cellular phone link, a radio frequency link, etc.

The computer system 1000 may further include a display interface 1002. The display interface 1002 may be configured to allow data to be transferred between the computer system 1000 and external display 1030. Exemplary display interfaces 1002 may include high-definition multimedia interface (HDMI), digital visual interface (DVI), video graphics array (VGA), etc. The display 1030 may be any suitable type of display for displaying data transmitted via the display interface 1002 of the computer system 1000, including a cathode ray tube (CRT) display, liquid crystal display (LCD), light-emitting diode (LED) display, capacitive touch display, thin-film transistor (TFT) display, etc. Computer program medium and computer usable medium may refer to memories, such as the main memory 1008 and secondary memory 1010, which may be memory semiconductors (e.g., DRAMs, etc.). These computer program products may be means for providing software to the computer system 1000. Computer programs (e.g., computer control logic) may be stored in the main memory 1008 and/or the secondary memory 1010. Computer programs may also be received via the communications interface 1024. Such computer programs, when executed, may enable computer system 1000 to implement the present methods as discussed herein. In particular, the computer programs, when executed, may enable processor device 1004 to implement the methods illustrated by FIGS. 1-9, as discussed herein. Accordingly, such computer programs may represent controllers of the computer system 1000. Where the present disclosure is implemented using software executed on hardware, the software may be stored in a computer program product and loaded into the computer system 1000 using the removable storage drive 1014, interface 1020, and hard disk drive 1012, or communications interface 1024.

The processor device 1004 may comprise one or more modules or engines configured to perform the functions of the computer system 1000. Each of the modules or engines may be implemented using hardware and, in some instances, may also utilize software executed on hardware, such as corresponding to program code and/or programs stored in the main memory 1008 or secondary memory 1010. In such instances, program code may be compiled by the processor device 1004 (e.g., by a compiling module or engine) prior to execution by the hardware of the computer system 1000. For example, the program code may be source code written in a programming language that is translated into a lower level language, such as assembly language or machine code, for execution by the processor device 1004 and/or any additional hardware components of the computer system 1000. The process of compiling may include the use of lexical analysis, preprocessing, parsing, semantic analysis, syntax-directed translation, code generation, code optimization, and any other techniques that may be suitable for translation of program code into a lower level language suitable for controlling the computer system 1000 to perform the functions disclosed herein. It will be apparent to persons having skill in the relevant art that such processes result in the computer system 1000 being a specially configured computer system 1000 uniquely programmed to perform the functions discussed above.

In accordance with an exemplary embodiment, the methods and processes as disclosed can be implemented on a non-transitory computer readable medium. The non-transitory computer readable medium may be a magnetic recording medium, a magneto-optic recording medium, or any other recording medium which will be developed in future, all of which can be considered applicable to the present invention in all the same way. Duplicates of such medium including primary and secondary duplicate products and others are considered equivalent to the above medium without doubt. Furthermore, even if an embodiment of the present invention is a combination of software and hardware, it does not deviate from the concept of the invention at all. The present disclosure may be implemented such that its software part has been written onto a recording medium in advance and will be read as required in operation.

As used herein, an element or step recited in the singular and preceded by the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional examples that also incorporate the recited features.

The patent claims at the end of this document are not intended to be construed under 35 U.S.C. § 112(f) unless traditional means-plus-function language is expressly recited, such as “means for” or “step for” language being expressly recited in the claim(s).

It will be apparent to those skilled in the art that various modifications and variation can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for document ownership for one or more users of a multifunction printer, the method comprising:
receiving, by the multifunction printer, a request to execute one or more of a print job and a scan job;
forwarding, by the multifunction printer, a request to a decentralized identity server for authorization to execute one or more of the print job and the scan job received by the multifunction printer;
receiving, by the multifunction printer, a response from the decentralized identity server for the authorization to execute the one or more of the print job and the scan job received by the multifunction printer; and
executing, by the multifunction printer, the one or more of the print job and the scan job when the response from the decentralized identity server authorizes the execution of the one or more of the print job and the scan job.

2. The method according to claim 1, further comprising:
sending, by the multifunction printer, a user identity associated with the request to execute the one or more of the print job and the scan job to the decentralized identity server; and
receiving, by the multifunction printer, the response from the decentralized identity server for the authorization to execute the one or more of the print job and the scan job received based on the user identity with the request to execute the one or more of the print job and the scan job.

3. The method according to claim 1, wherein the one or more of the print job and the scan job is the print job, further comprising:
printing, by the multifunction printer, the print job with a decentralized identity code on contents of the printed print job, and wherein the decentralized identity code is one or more of a uniform resource locator, a quick response code, and a user identifier.

4. The method according to claim 3, further comprising:
receiving, by the multifunction printer, a request to execute scanning of the printed print job with the decentralized identity code on the contents of the printed print job;
sending, by the multifunction printer, the decentralized identity code from the printed print job to the decentralized identity server for authorization to execute the scanning of the printed print job; and
receiving, by the multifunction printer, the response from the decentralized identity server for the authorization to execute the scan job based on the decentralized identify code.

5. The method according to claim 4, further comprising:
reading, by the multifunction printer, the decentralized identity code on the contents of the printed print job; and
sending, by the multifunction printer, the read decentralized identity code on the contents of the printed print job to the decentralized identity server.

6. The method according to claim 1, further comprising:
authenticating, by the multifunction printer, a user of the multifunction printer associated with the one or more of the print job and the scan job based on a biometric identifier for the user, and the biometric identifier is from a biometric authenticator device associated with one of the multifunction printer and a client device, the biometric authenticator device including one or more of a sensor, a scanning device, or an electronic reader, and wherein the biometric identifier of the user being at least one physiological characteristic of the user, and wherein the at least one physiological characteristic is selected from one or more of fingerprints, palm veins, face recognition, DNA (deoxyribonucleic acid), palm print, hand geometry, iris recognition, retina, and/or odor/scent.

7. The method according to claim 6, wherein the client device is a mobile device, a smart phone, or a wearable device, and wherein the method further comprises:
communicating, by the multifunction printer, to the client device of the user via a wireless communication protocol, the wireless protocol being a near-field communication (NFC) or a Bluetooth technology standard.

8. A method for document ownership associated with a multifunction printer, the method comprising:
receiving, by a decentralized identity server, a request for authorization to execute one or more of a print job and a scan job from the multifunction printer;
retrieving, by the decentralized identity server from a distributed ledger, one or more permissions for the one or more of the print job and the scan job;
determining, by the decentralized identity server, if the multifunction printer is authorized to execute the one or more of the print job and the scan job based on the retrieved one or more permissions for the one or more of the print job and the scan job; and
sending, by the decentralized identity server, a response to the request for authorization to execute the one or more of the print job and the scan job to the multifunction printer with approval or denial of the request for authorization to execute the one or more of the print job or the scan job based on the determination of the retrieved one or more permissions for the one or more of the print job and the scan job.

9. The method according to claim 8, further comprising:
receiving, by the decentralized identity server, a user identifier associated with the request for authorization to execute the one or more of the print job and the scan job from the multifunction printer; and
determining, by the decentralized identity server, if the multifunction printer is authorized to execute the one or more of the print job and the scan job based on the received user identifier and the retrieved one or more permissions for the one or more of the print job and the scan job from the distributed ledger.

10. The method according to claim 9, further comprising:
receiving, by decentralized identity server, the one or more permissions for the one or more of the print job and the scan job; and
recording, by the decentralized identity server, the one or more permissions for the one or more of the print job and the scan job on the distributed ledger.

11. The method according to claim 8, further comprising:
sending, by the decentralized identity server, a notification to one or more users associated with the request for authorization received from the multifunction printer to execute the one or more of the print job and the scan job.

12. The method according to claim 8, wherein the distributed ledger is a blockchain.

13. The method according to claim 8, wherein the one or more of the print job and the scan job is a scan job, further comprises:
receiving, by the decentralized identity server, a decentralized identity code from the multifunction printer, the decentralized identity code being on contents of a scanned document;
determining, by the decentralized identity server, if the multifunction printer is authorized to execute the scan job based on the decentralized identity code and permissions associated with the decentralized identity code; and
sending, by the decentralized identity server, the response to the request for authorization to execute the scan job to the multifunction printer with approval or denial of the request for authorization to execute the scan job.

14. The method according to claim 8, further comprising:
recording, by the decentralized identity server on the distributed ledger, a history for the one or more of the print job and the scan job that have been printed or scanned including when printed or scanned and an identifier associated with the history for the one or more of the print job and the scan job that have been printed or scanned.

15. The method according to claim 14, further comprising:
sending, by the decentralized identity server, a notification to one or more users that the one or more of the print job or the scan job has been determined to be obsolete based on a predetermined setting associated with the one or more of the print job or the scan job.

16. A system for document ownership, the system comprising:
a multifunction printer having a processor configured to:
receive a request to execute one or more of a print job and a scan job;
forward a request to a decentralized identity server for authorization to execute one or more of the print job and the scan job received by the multifunction printer;
receive a response from the decentralized identity server for the authorization to execute the one or more of the print job and the scan job received by the multifunction printer; and
execute the one or more of the print job and the scan job when the response from the decentralized identity server authorizes the execution of the one or more of the print job and the scan job.

17. The system according to claim 16, wherein the processor of the multifunction printer is configured to:
send a user identity associated with the request to execute the one or more of the print job and the scan job to the decentralized identity server; and
receive the response from the decentralized identity server for the authorization to execute the one or more of the print job and the scan job received based on the user identity with the request to execute the one or more of the print job and the scan job.

18. The system according to claim 16, wherein the one or more of the print job and the scan job is the print job, and the processor of the multifunction printer is configured to:
print the print job with a decentralized identity code on contents of the printed print job, and wherein the decentralized identity code is one or more of a uniform resource locator, a quick response code, and a user identifier.

19. The system according to claim 18, wherein the processor of the multifunction printer is configured to:
receive a request to execute scanning of the printed print job with the decentralized identity code on the contents of the printed print job;
send the decentralized identity code from the printed print job to the decentralized identity server for authorization to execute the scanning of the printed print job; and
receive the response from the decentralized identity server for the authorization to execute the scan job based on the decentralized identify code.

20. The system according to claim 16, further comprising:
the decentralized identity server, the decentralized identity server having a processor configured to:
receive the request for authorization to execute the one or more of the print job and the scan job from the multifunction printer;
retrieve from a distributed ledger, one or more permissions for the one or more of the print job and the scan job;
determine if the multifunction printer is authorized to execute the one or more of the print job and the scan job based on the retrieved one or more permissions for the one or more of the print job and the scan job; and
send the response to the request for authorization to execute the one or more of the print job and the scan job to the multifunction printer with approval or denial of the request for authorization to execute the one or more of the print job or the scan job based on the determination of the retrieved one or more permissions for the one or more of the print job and the scan job.
